(19) United States
(12) Patent Application Publication
(10) Pub. No.: US 2022/0027141 A1
(43) Pub. Date: Jan. 27, 2022

(54) NETWORK FUNCTION UPGRADE METHOD, SYSTEM AND APPARATUS

(71) Applicant: TELEFONAKTIEBOLAGET LM ERICSSON (PUBL), 164 83 Stockholm (SE)

(72) Inventor: Zu QIANG, Kirkland (CA)

(73) Assignee: TELEFONAKTIEBOLAGET LM ERICSSON (PUBL), Stockholm (SE)

(21) Appl. No.: 17/311,423

(22) PCT Filed: Dec. 9, 2019
(86) PCT No.: PCT/IB2019/060580

§ 371 Date: Jun. 7, 2021

Related U.S. Application Data
(60) Provisional application No. 62/777,447, filed on Dec. 10, 2018.

(51) Int. Cl. G06F 8/65

(52) U.S. Cl. CPC G06F 8/65

(57) ABSTRACT

A method, system and apparatus to upgrade physical network function(s) (PNF) software. The method including selecting an upgrade option based on a pre-established indicator. The system having one or more processors and memory storing instructions that, when executed by the one or more processors, cause the system to execute the method. The apparatus including a non-transitory computer readable medium having instructions that, when executed, cause one or more processors to execute the method.

### TECHNICAL FIELD

The present invention relates generally to network function (NF) software upgrades, relates more particularly to the selection of specific upgrade option(s) for NF software upgrades.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As underlying networks and applications transform to new architectures and technologies, this creates more complexity to operations and life cycle management of services. Automation is key to manage these complex networks, applications in various stages such as PNF (Physical Network Functions), VNF (Virtual Network Functions) and CNF (Cloud Native Network Functions), massive number of devices, different types of devices and services across many industries.

ONAP provides a comprehensive platform for real-time, policy-driven orchestration and automation of physical and virtual network functions that will enable software, network, IT and cloud providers and developers to rapidly automate new services and support complete lifecycle management.

By unifying member resources, ONAP will accelerate the development of a vibrant ecosystem around a globally shared architecture and implementation for network automation—with an open standard focus—faster than any one product could on its own.

There currently exist certain challenge(s).

In a wireless network implementing 5G communication standards, ONAP is required to support network function, such as PNF, onboarding and upgrade. There are various options for network function software upgrade that utilize an external controller (EC) to perform the software upgrade. These options may be generally categorized into four schema update (SU) options, namely: option 1—build-replace update using a new network function package; option 2—in-place update using a new network function package; option 3—in-place update using get-schema; and option 4—in-place update using file-ready.

These schema update (SU) options may be further described as follows: when a schema update is based on a new package onboarding to the ONAP visual modeling and design tool known as Service Design and Creation (SDC), the package may contain CM/PM/FM artifacts and may contains upgrade artifacts including pre-check script, post-check script, upgrade script, and upgrade path list.

Schema update 1 (SU1) relates to the build-replace schema updates via vendor specific scripts. This provides a new package having new update scripts in the package.

Schema update 2 (SU2) relates to the in-place schema updates via vendor specific scripts. This provides a new package having new update scripts in the package.

There are situations when a schema update is not based on SDC involvements and is from a network function directly. In these situations, schema update 3 (SU3) relates to updates via get-schema. SU3 does not require a new package or scripts. The schema update is per instance driven by network function.

In a related situation, schema update 4 (SU4) relates to updates via file-ready. In this schema, ONAP is notified of the new schema by a file-ready VES event. No new package or scripts are required. The schema update is per instance driven by network function.

In the situation where no schema update is required, Schema update 5 (SU5) provides no new package or script. The software upgrade is via ONAP UI or another tool directly.

One challenge is that a ONAP micro service (e.g. PRH) or a service orchestrator (SO) may not have the knowledge of which option is selected for the network function upgrade, and as such may not know if a specific procedure needs to be performed.

### SUMMARY

Some aspects herein perform a method to upgrade network function(s) (NF) software. The method includes selecting an upgrade option for the network function (NF) software, the upgrade being based on a pre-established indicator, which may be created by an ONAP operator.

Some aspects are directed toward a physical network function (PNF). This is illustrative and not meant to be limiting. The current invention is directed to be applicable with any network function, such as a virtual network function (VNF).

In some aspects, the upgrade option may be a build-replace update using a new PNF package, an in-place update, i.e. the installation of an upgrade option(s) without first removing the older version of the software, using a new PNF package, an in-place update using get-schema or an in-place update using file-ready.

In some aspects, the upgrade option may be selected if the selected upgrade option is supported and/or rejecting the upgrade option if the selected upgrade option is not supported.

In some aspects, the method may also include conducting a pre-check to determine if a set of pre-conditions are satisfied. In these aspects, the pre-requirements may be selected from one or more of the group consisting of: a determination that the DMaaP is up and running, the A&Al is up and running with a valid PNF entry, the SDNC is up and running, the EM and PNF are up and running with assigned IP addresses and ports, and the PNF instance is ready to send a PNF registration VES event.

In additional aspects, the pre-requirements may be selected from one or more of the group consisting of: ONAP is ready to use, at least one SO upgrade workflow is ready to use, a SDC service template with one PNF resource is designed and is distributed to run time, and service instantiation is completed.

In some aspects, the method may further include prior to the selecting an upgrade option for the physical network function (PNF) software, an operator selecting a work-flow and a PNF instance to be upgraded, providing a target software version of the PNF instance, and initiating the upgrade procedure to upgrade the PNF instance. In these aspects, the method may further include a service orchestrator (SO) sending at least one request to a controller to upgrade the PNF instance, the at least one request including the pre-established indicator, the controller executing the at least one request to facilitate the upgrading of the PNF instance where the execution is based on the pre-established indicator, and the SO updating the PNF instance's information on an Active and Available Inventory (A&AI) with the upgrade software-version when the upgrade is completed.

Some aspects herein provide a computer program that upgrades physical network function(s) (PNF) software. The computer program having instructions which, when executed by at least one processor and to perform by the at least one processor the method of the present invention.

Some aspects herein provide a system that upgrades physical network function(s) (PNF) software. The system includes one or more processors and memory storing instructions that, when executed by the one or more processors, cause the system to perform any of the aspects of the method of the present invention.

Some aspects herein provide a non-transitory computer readable medium including instructions that, when executed, cause one or more processors to perform any of the aspects of the method of the present invention.

### BRIEF DESCRIPTION OF THE DRAWINGS

FIG. 1 illustrates a block diagram of a system operating according to some embodiments of the present disclosure.

FIG. 2 illustrates an exemplary software upgrade workflow according to some embodiments of the present disclosure.

FIG. 3 illustrates an embodiment of an upgrade procedure according to some embodiments of the present disclosure.

FIG. 4 is a block diagram of a wireless communication network according to some embodiments.

FIG. 5 is a block diagram of a user equipment according to some embodiments.

FIG. 6 is a block diagram of a virtualization environment according to some embodiments.

FIG. 7 is a block diagram of a communication network with a host computer according to some embodiments.

FIG. 8 is a block diagram of a host computer according to some embodiments.

FIG. 9 is a flowchart illustrating a method implemented in a communication system, in accordance with one embodiment.

FIG. 10 is a flowchart illustrating a method implemented in a communication system, in accordance with one embodiment.

FIG. 11 is a flowchart illustrating a method implemented in a communication system, in accordance with one embodiment.

FIG. 12 is a flowchart illustrating a method implemented in a communication system, in accordance with one embodiment.

FIG. 13 is a method according to some embodiments of the present disclosure.

FIG. 14 illustrates a schematic block diagram of an apparatus in a wireless network.

### DETAILED DESCRIPTION

Some of the embodiments contemplated herein may provide solutions to the above set out, or other, challenges. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

There are various embodiments which address one or more of the issues disclosed herein. In general, the embodiments are directed toward the selection of specific upgrade option(s) for NF software upgrades. Some embodiments are directed toward a physical network function (PNF). This is illustrative and not meant to be limiting. The current invention is directed to be applicable with any network function, such as a virtual network function (VNF).

Certain aspects of the present invention may provide solutions to the above or other challenges. The proposed solution is to allow a specific upgrade option based on a flag set by an ONAP operator or service owner. This solution will allow the different upgrade options to be more easily processed while optimizing the upgrade procedure.

Certain embodiments may allow a specific upgrade option based on a flag set by ONAP operator. The flag can be otherwise referred to a pre-established indicator. Further, the flag may be saved in a run time catalogue. For example, if an update, sometimes known as a schema update, is based on elements from ONAP's visual modeling and design tool known as SDC, and which may contain CM/PM/FM artifacts and may contains upgrade artifacts including pre-check script, post-check script, upgrade script, and upgrade path list, the ONAP operator may select either to use a build-replace schema update via vendor specific scripts procedure, the above mentioned option 1, use an in-place update, or use an in-place schema updates via vendor specific scripts procedure, the above mentioned option 2.

Referring now also to Figures, other aspects of the disclosure and embodiments of these aspects are discussed.

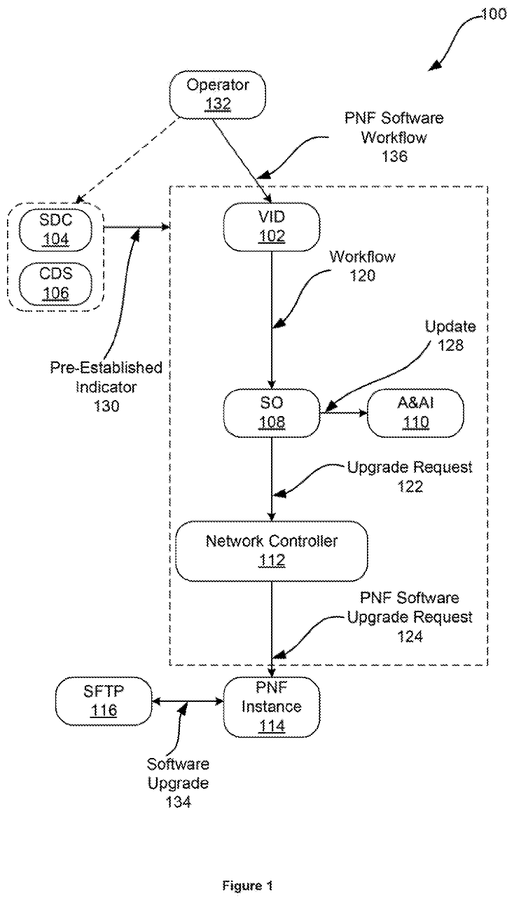

FIG. 1 illustrates a block diagram of a system 100 operating according to some embodiments of the present disclosure. System 100 includes an ONAP Service Orchestrator (SO) 108 that is a component that provides orchestration at a very high level, with an end to end view of the infrastructure, network, and applications. The SO 108 receives a workflow 120 that identifies a PNF instance 114, a target software upgrade 134, i.e. the software upgrade for the PNF instance, and a pre-established indicator 130.

The SO 108 will then execute workflow 120 by determining the appropriate upgrade option based on the pre-established indicator 130. The SO will then continue to execute the workflow by sending an upgrade request 122 to a controller 112. The upgrade request 122 will include the PNF instance 114, the target software upgrade 134, and established upgrade option based on the pre-established indicator 130. The controller 112, which can also be referred to as a SDN-C or SDNC, manages the state of a resource. It executes the resource's configuration and instantiation, and is the primary agent in ongoing management, such as control loop actions, migration, and scaling.

The controller 112 will then execute the upgrade request 122 by sending a PNF software upgrade request 124 to the PNF instance 114. The PNF software upgrade request 124 upgrade will be based on the received upgrade request 122.

Upon receiving the PNF software upgrade request 124, PNF instance 114 will request, and will receive back from, from a file server 116 the appropriate software upgrade where the software upgrade 134 is stored. The file server 116 may be any suitable file server such as a secured FTP server, sometimes referred to a SFTP server.

Following a successful upgrade, the SO 108 updates the PNF instance record in the Active and Available Inventory (A&AI) 110 with the recently upgrade software information.

In some embodiments, an Operator 132 may select an appropriate PNF Software Upgrade workflow 136 and execute the workflow. The Operator 132 may perform this operation through a Virtual Infrastructure Deployment (VID) application 102 which enables users to create, modify or delete infrastructure services instances and their associated components. The Operator 132 may select an appropriate network function software upgrade work-flow and execute that work-flow. When selecting the network function, the Operator should indicate the network function group name of the network function instances which will be upgraded. The network function group name can be in any format, e.g. a wild-card of a network function name, or location of the network function instance. After the Operator 132 inputs the appropriate data, the VID may trigger the SO 108 to perform instantiation operations.

In some embodiments, the Operator 132 may create the pre-established indicator 130. The Operator 132 may perform this operation through a Service Design and Creation application (SDC) 104, which is the ONAP visual modeling and design tool. The SDC 104 creates internal metadata that describes assets used by all ONAP components, both at design time and run time.

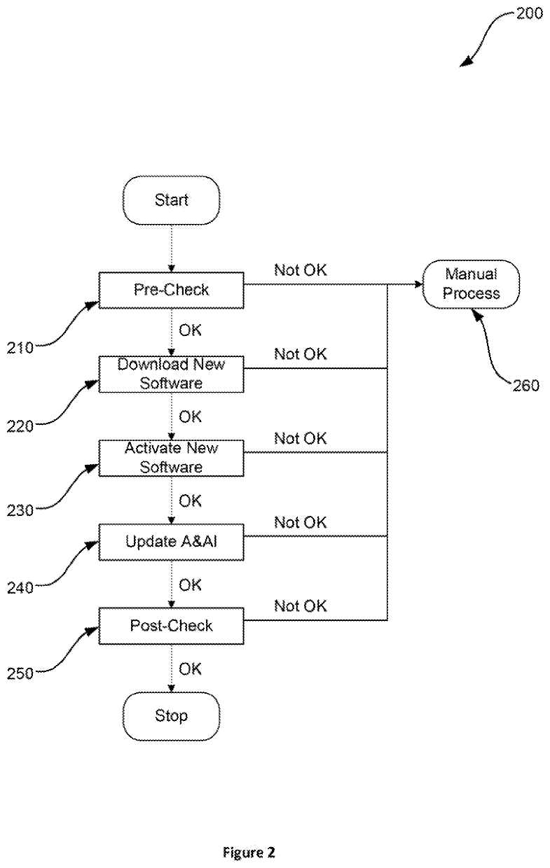

As illustrated in FIG. 2, an embodiment of an exemplary software upgrade workflow 200 in an ONAP system (for example, the system shown in FIG. 1). The workflow 200 is described with reference to FIG. 1 respectively and possibly any other systems disclosed herein. It is also to be understood that the workflow of FIG. 2 is not necessarily carried out solely by system 100. At least some operations of the workflow can be performed by one or more other entities.

After the SO 108 receives workflow 120, SO 108 will perform any pre-check 210 that may be required. This may include the SO 108 determining if the PNF instance is in service and in health, as well as determining that the software image of the target software version, i.e. the software upgrade, is available for downloading on file server 116, and was actually downloaded to the PNF instance. The pre-check may also include checking any required and/or associated rule, collection of necessary data for pre-checking, etc. The pre-check 210 will either be accepted or not. If it is not accepted, i.e. not okay, the workflow proceeds to a manual process 260 in order to upgrade the PNF instance.

If the pre-check 210 is accepted, the SO 108 works with controller 112 to perform the upgrade. This includes downloading the new software 220 within the PNF instance 114 and then activating the new software 230 within the PNF instance 114. If either the downloading or activating 220, 230 of the new software fails, the workflow 200 proceeds to manual process 260.

After the activation of the new software 230, the SO 108 may send an update 240 to the A&Al 110 for the associated PNF instance.

The SO 108 may then perform any post-check 240 that may be required. This includes determining that the new software activation is completed and PNF instance is running is target software version, as well as determining that the new software version of the PNF instance is updated in A&Al 110.

The pre-check 220 and post-check 230 may be performed in stages based on the progress through the workflow 200. For example, the pre-check 220 and post-check 230 may be split between the downloading and activation of the new software.

In some embodiments, the network elements may be any network function, including Physical Network Functions (PNF) and/or Virtual Network Functions (VNF).

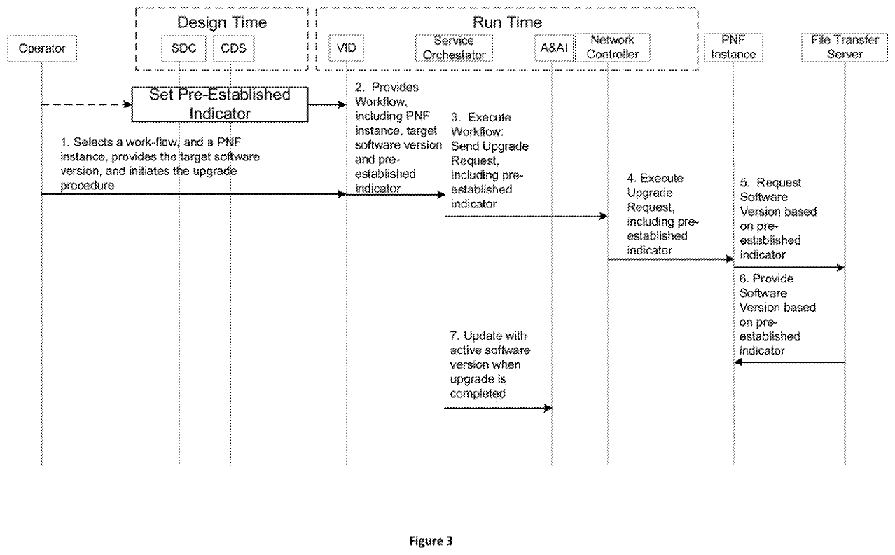

The method actions performed by the system 100 for upgrading network elements according to embodiments will now be described with reference to a flowchart depicted in FIG. 3. The actions do not have to be taken in the order stated below, but may be taken in any suitable order. The embodiments in FIG. 3 are directed toward the upgrading of physical network functions (PNFs). However, this is illustrative and not meant to be limiting. Those skilled in the art will recognize that other network functions, such as virtual network functions (VNFs), may be upgraded through embodiments of the present disclosure.

The following steps are detailed as follows:

Step 1. An Operator 132 may select an appropriate PNF Software Upgrade work-flow and execute the work-flow. The step may be performed using a Virtual Infrastructure Deployment (VID) application 102 which enables a user to create, modify or delete infrastructure services instances and their associated components. When selecting the appropriate work-flow, the Operator 132 may set a pre-established indicator which will indicate the desired upgrade procedure option. The pre-established indicator may be performed using a Service Design and Creation application (SDC) 104, which is the ONAP visual modeling and design tool.

Step. 2. After an operator inputs the appropriate data, the VID 102 may trigger an ONAP Service Orchestrator (SO) 108 to perform the upgrade operations. The VID 102 may provide the workflow, that includes PNF instance 114, target software version 134 and the pre-established indicator 130 to the SO 108 for further processing.

Step 3. The SO 108 executes the workflow, that includes sending an upgrade request to a controller 112. The upgrade request includes PNF instance 114 to be upgraded, along with the instructions for the selected upgrade based on the desired upgrade procedure option as indicated by the pre-established indicator 130.

Step 4. The controller 112 executes the upgrade request that includes performing the upgrading of the PNF instance 114.

Step 5. The PNF instance 114 requests from a file transfer server 116 the desired new software upgrade 134.

Step 6. The file transfer server 134 provided the requested new software upgrade to the PNF instance 114.

Step 7. After the upgrade is completed, the SO 108 updates all corresponding A&Al entries 110.

For additional example, if an update does not include SDC involvements, the update may come from the PNF directly. In such example, the ONAP operator may select to use an in-place schema updates via get-schema procedure, the above-mentioned option 3, where the schema update is per instance driven by xNF. The ONAP operator may also select to use an in-place schema updates via file-ready procedure, the above-mentioned option 4, where ONAP is notified of the new schema updated by a file-ready VES event.

In an operational example, if the ONAP operator selects either option 1 or 2, the operator at the VID can select an appropriate PNF software upgrade workflow and then execute the workflow. The SO identifies the appropriate Controller, verifies and queries the A&Al for the appropriate PNF entries. Based on the query result, the SO informs the ONAP Controller with the PNF name. The SO then sets the A&Al entry with a flag “pending for delete after upgrade” if option 1 was selected or “pending for update” if option 2 was selected. The ONAP Controller, e.g. SDN-C, works with an external controller (EC) to perform any pre-check, upgrade and post-check functions. After the upgrade is complete in the PNF, a PNF-registration is sent.

When the PNF registration is received, the PRH uses the PNF-name to query the A&Al entry. Based on the response to the A&Al query, an option is selected. For example, if the response is that two entries have the same PNF name and one entry has a flag of “pending for delete after upgrade”, then option 1 procedure may be triggered. If, however, the response is that there is one entry which has a flag of “pending for update”, then option 3 procedure may be triggered. Further, if the response is that there is only one entry but without any flag, then option 3 or 4 procedure may be triggered.

In some embodiments, the pre-check may include a determination of whether a set of pre-requirements are satisfied. These pre-requirements may include a determination that the DMaaP is up and running; the A&Al is up and running with a valid PNF entry; the SDNC is up and running; the EM and PNF are up and running with assigned IP addresses and ports; and the PNF instance is ready to send a PNF registration VES event.

In some embodiments of the PNF Registration, when receiving a pnfRegistration event, the ONAP microservice (PRH) updates the A&Al entry with the received IP address and software version. To support the PNF software upgrade and schema update procedure, PNF must be able to send the pnfRegistration every time after a restart/reload/update. Further, when receiving the pnfRegistration event, the ONAP microservice must compare the received software version with the stored value.

In some embodiments, if there is a mismatch, the method determines if one or more schema update options are support. If the schema update is not supported, the registration may be rejected or the A&Al entry may be updated. If the schema update option 3 & 4 is supported, the A&Al entry may be updated with received software version, with an update flag added which may trigger the schema update at any time. If the schema update option 1 or 2 is supported, the A&Al entry may be updated with received software version, and the model id may be updated.

In additional embodiments, an update may include an in-place replacement of the software. In such embodiments various scenario may present themselves.

In embodiments of a first scenario, the PNF software upgrade is one aspect of Software Management. The purpose of this procedure is to upgrade the software currently running on the PNF to a target software version without impacts on PNF schema and service template.

In these embodiments, the enhancement and additions of PNF in-place software update is the primary focus. These embodiments include direct PNF NETCONF interface support with the vendor-specific YANG model. An enhanced SO in-place software upgrade workflow with generic SO building blocks is provided which can be used for workflow design in the design time. The use of a CDS self-service API between the SO and the controller is provided with the support of PNF in-place software upgrade. An enhanced VID is used to demonstrate single PNF in-place software upgrade. An enhanced SO procedure is used to support AAI update after the software upgrade completion.

In these embodiments, various preconditions are considered. These precondition may include: ONAP is ready to use; SO upgrade workflows are ready to use; a SDC service template with one PNF resource is designed (including CBA association) and it is distributed to run time; and/or service instantiation is completed, including PNF PnP, where the PNF instance is in operation with connectivity between PNF-ONAP, PNF-SFTP

In these embodiments, the method for upgrading of one PNF instance is considered. These methods include a vendor delivering the new software upgrade, also known as a software image, to the operator and storing the new software image in the file transfer server. An operator at the VID, selects a work-flow and a PNF instance, provides the target software version, and initiates the upgrade procedure. The SO executes the workflow by sending a Controller Design Studio (CDS) request(s) with action-identifier {actionName, blueprintName, blueprintVersion} to the blueprint processor inside the controller using CDS selfservice API. The controller/blueprint processor executes the blueprint scripts including sending Netconf request(s) to the PNF instance for upgrading. Following the upgrade, the SO updates the A&Al with the new software-version when the upgrade is completed.

In embodiments of a second scenario, support for PNF software upgrade with schema update including service level LCM operations is provided. In these embodiments, the PNF software upgrade based on the updated service template, the PNF schema update is based on the updated service template, the service template update includes multiple resource instances, which may include updating the design time service template using vendor provided onboarding package, upgrading a run time service instance based on the updated service template, updating the run time catalog at software upgrade completion

The use of a schema update allows for a Vendor to deliver a PNF box with pre-installed software, and aPNF package which describes the functions supported by the PNF box.

After PNF is up and running in ONAP, a new software version may be delivered which software upgrade may be triggered. Once the PNF software is upgraded, a new software version is running in the PNF box, which may introduce new functions. Without updating the run time catalog (artifacts association), the ONAP is not aware of any of new functions, e.g. new PM counters, new CM Yang model, new Alarms, etc.

In these embodiments, the schema update procedure may include a vendor shall providing a new PNF package with updated artifacts, and the new PNF software image to the operator. An operator may, at receiving of the new PNF package, onboard the new PNF package and create a new resource or update the existing resource template, update the existing service template with the new or updated resource template, and distribute the updated service template to run time.

At run time, the operator shall, based on the updated service template, upgrade PNF software based on the updated resource template, and update the run time catalog with the updated resource template.

These embodiments allow for the onboarding of the software version information using vendor provided onboarding package and providing supporting software version in internal model. The upgrade path information may be stored at the design time. This may include the resource upgrade path and the service upgrade options. The upgrade may be run at the service level (SO) which allow for the executing of the workflow at service level. Further, the run time catalog may be updated to provide support with updating resource model ID/version and updating service model ID/version.

In embodiments of a third scenario, the PNF software upgrade utilizes Ansible. In these embodiments, in PNF pre-onboarding, the operator delivers the PNF packages, including necessary ansible artifacts, to the SDC. In the software upgrade runtime, the operator initiates the command, via VID or timer, to SO. The SO executes the software upgrade task, like A&Al retrieval, and sends an LCM requests to the controller. An Ansible adaptor forwards the requests to an external monitor (EM) via ansible server.

In embodiments of a fourth scenario, the PNF software upgrade utilizes a Netconf/Yang interface with an external monitor (EM). The purpose of the scenario provides external monitor integration to the embodiments of scenario 1.

In these embodiments, in PNF pre-onboarding, the operator delivers the PNF packages, including necessary controller blueprint artifacts, to the SDC. In the software upgrade run time, the operator initiates the command, via VID or timer, to SO. The SO will execute the software upgrade task, such as A&Al retrieval, and sends needed requests, such as SS-API requests, to the controller. An executor forwards the requests to EM with the netconf/yang interface.

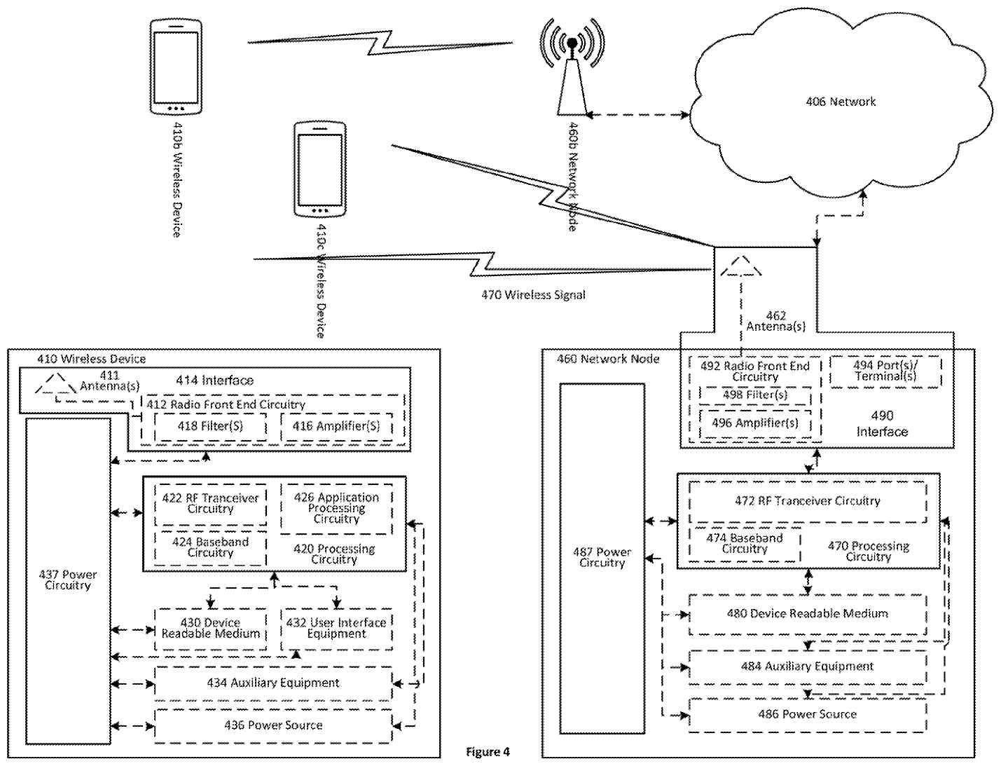

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 406, network nodes 460 and 460b, and WDs 410, 410b, and 410c. In practice, a wireless network may further include any additional elements suitable to support communication between wireless devices or between a wireless device and another communication device, such as a landline telephone, a service provider, or any other network node or end device. Of the illustrated components, network node 460 and wireless device (WD) 410 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 406 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 460 and WD 410 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 460 includes processing circuitry 470, device readable medium 480, interface 490, auxiliary equipment 484, power source 486, power circuitry 487, and antenna 462. Although network node 460 illustrated in the example wireless network of FIG. 4 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 460 are depicted as single boxes located within a larger box, or nested within multiple boxes, in practice, a network node may comprise multiple different physical components that make up a single illustrated component (e.g., device readable medium 480 may comprise multiple separate hard drives as well as multiple RAM modules).

Similarly, network node 460 may be composed of multiple physically separate components (e.g., a NodeB component and a RNC component, or a BTS component and a BSC component, etc.), which may each have their own respective components. In certain scenarios in which network node 460 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 460 may be configured to support multiple radio access technologies (RATs). In such embodiments, some components may be duplicated (e.g., separate device readable medium 480 for the different RATs) and some components may be reused (e.g., the same antenna 462 may be shared by the RATs). Network node 460 may also include multiple sets of the various illustrated components for different wireless technologies integrated into network node 460, such as, for example, GSM, WCDMA, LTE, NR, WiFi, or Bluetooth wireless technologies. These wireless technologies may be integrated into the same or different chip or set of chips and other components within network node 460.

Processing circuitry 470 is configured to perform any determining, calculating, or similar operations (e.g., certain obtaining operations) described herein as being provided by a network node. These operations performed by processing circuitry 470 may include processing information obtained by processing circuitry 470 by, for example, converting the obtained information into other information, comparing the obtained information or converted information to information stored in the network node, and/or performing one or more operations based on the obtained information or converted information, and as a result of said processing making a determination.

Processing circuitry 470 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 460 components, such as device readable medium 480, network node 460 functionality. For example, processing circuitry 470 may execute instructions stored in device readable medium 480 or in memory within processing circuitry 470. Such functionality may include providing any of the various wireless features, functions, or benefits discussed herein. In some embodiments, processing circuitry 470 may include a system on a chip (SOC).

In some embodiments, processing circuitry 470 may include one or more of radio frequency (RF) transceiver circuitry 472 and baseband processing circuitry 474. In some embodiments, radio frequency (RF) transceiver circuitry 472 and baseband processing circuitry 474 may be on separate chips (or sets of chips), boards, or units, such as radio units and digital units. In alternative embodiments, part or all of RF transceiver circuitry 472 and baseband processing circuitry 474 may be on the same chip or set of chips, boards, or units.

In certain embodiments, some or all of the functionality described herein as being provided by a network node, base station, eNB or other such network device may be performed by processing circuitry 470 executing instructions stored on device readable medium 480 or memory within processing circuitry 470. In alternative embodiments, some or all of the functionality may be provided by processing circuitry 470 without executing instructions stored on a separate or discrete device readable medium, such as in a hard-wired manner. In any of those embodiments, whether executing instructions stored on a device readable storage medium or not, processing circuitry 470 can be configured to perform the described functionality. The benefits provided by such functionality are not limited to processing circuitry 470 alone or to other components of network node 460, but are enjoyed by network node 460 as a whole, and/or by end users and the wireless network generally.

Device readable medium 480 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 470. Device readable medium 480 may store any suitable instructions, data or information, including a computer program, software, an application including one or more of logic, rules, code, tables, etc. and/or other instructions capable of being executed by processing circuitry 470 and, utilized by network node 460. Device readable medium 480 may be used to store any calculations made by processing circuitry 470 and/or any data received via interface 490. In some embodiments, processing circuitry 470 and device readable medium 480 may be considered to be integrated.

Interface 490 is used in the wired or wireless communication of signalling and/or data between network node 460, network 406, and/or WDs 410. As illustrated, interface 490 comprises port(s)/terminal(s) 494 to send and receive data, for example to and from network 406 over a wired connection. Interface 490 also includes radio front end circuitry 492 that may be coupled to, or in certain embodiments a part of, antenna 462. Radio front end circuitry 492 comprises filters 498 and amplifiers 496. Radio front end circuitry 492 may be connected to antenna 462 and processing circuitry 470. Radio front end circuitry may be configured to condition signals communicated between antenna 462 and processing circuitry 470. Radio front end circuitry 492 may receive digital data that is to be sent out to other network nodes or WDs via a wireless connection. Radio front end circuitry 492 may convert the digital data into a radio signal having the appropriate channel and bandwidth parameters using a combination of filters 498 and/or amplifiers 496. The radio signal may then be transmitted via antenna 462. Similarly, when receiving data, antenna 462 may collect radio signals which are then converted into digital data by radio front end circuitry 492. The digital data may be passed to processing circuitry 470. In other embodiments, the interface may comprise different components and/or different combinations of components.

In certain alternative embodiments, network node 460 may not include separate radio front end circuitry 492, instead, processing circuitry 470 may comprise radio front end circuitry and may be connected to antenna 462 without separate radio front end circuitry 492. Similarly, in some embodiments, all or some of RF transceiver circuitry 472 may be considered a part of interface 490. In still other embodiments, interface 490 may include one or more ports or terminals 494, radio front end circuitry 492, and RF transceiver circuitry 472, as part of a radio unit (not shown), and interface 490 may communicate with baseband processing circuitry 474, which is part of a digital unit (not shown).

Antenna 462 may include one or more antennas, or antenna arrays, configured to send and/or receive wireless signals. Antenna 462 may be coupled to radio front end circuitry 490 and may be any type of antenna capable of transmitting and receiving data and/or signals wirelessly. In some embodiments, antenna 462 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 462 may be separate from network node 460 and may be connectable to network node 460 through an interface or port.

Antenna 462, interface 490, and/or processing circuitry 470 may be configured to perform any receiving operations and/or certain obtaining operations described herein as being performed by a network node. Any information, data and/or signals may be received from a wireless device, another network node and/or any other network equipment. Similarly, antenna 462, interface 490, and/or processing circuitry 470 may be configured to perform any transmitting operations described herein as being performed by a network node. Any information, data and/or signals may be transmitted to a wireless device, another network node and/or any other network equipment.

Power circuitry 487 may comprise, or be coupled to, power management circuitry and is configured to supply the components of network node 460 with power for performing the functionality described herein. Power circuitry 487 may receive power from power source 486. Power source 486 and/or power circuitry 487 may be configured to provide power to the various components of network node 460 in a form suitable for the respective components (e.g., at a voltage and current level needed for each respective component). Power source 486 may either be included in, or external to, power circuitry 487 and/or network node 460. For example, network node 460 may be connectable to an external power source (e.g., an electricity outlet) via an input circuitry or interface such as an electrical cable, whereby the external power source supplies power to power circuitry 487. As a further example, power source 486 may comprise a source of power in the form of a battery or battery pack which is connected to, or integrated in, power circuitry 487. The battery may provide backup power should the external power source fail. Other types of power sources, such as photovoltaic devices, may also be used.

Alternative embodiments of network node 460 may include additional components beyond those shown in FIG. 4 that may be responsible for providing certain aspects of the network node's functionality, including any of the functionality described herein and/or any functionality necessary to support the subject matter described herein. For example, network node 460 may include user interface equipment to allow input of information into network node 460 and to allow output of information from network node 460. This may allow a user to perform diagnostic, maintenance, repair, and other administrative functions for network node 460.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 410 includes antenna 411, interface 414, processing circuitry 420, device readable medium 430, user interface equipment 432, auxiliary equipment 434, power source 436 and power circuitry 437. WD 410 may include multiple sets of one or more of the illustrated components for different wireless technologies supported by WD 410, such as, for example, GSM, WCDMA, LTE, NR, WiFi, WiMAX, or Bluetooth wireless technologies, just to mention a few. These wireless technologies may be integrated into the same or different chips or set of chips as other components within WD 410.

Antenna 411 may include one or more antennas or antenna arrays, configured to send and/or receive wireless signals, and is connected to interface 414. In certain alternative embodiments, antenna 411 may be separate from WD 410 and be connectable to WD 410 through an interface or port. Antenna 411, interface 414, and/or processing circuitry 420 may be configured to perform any receiving or transmitting operations described herein as being performed by a WD. Any information, data and/or signals may be received from a network node and/or another WD. In some embodiments, radio front end circuitry and/or antenna 411 may be considered an interface.

As illustrated, interface 414 comprises radio front end circuitry 412 and antenna 411. Radio front end circuitry 412 comprise one or more filters 418 and amplifiers 416. Radio front end circuitry 414 is connected to antenna 411 and processing circuitry 420, and is configured to condition signals communicated between antenna 411 and processing circuitry 420. Radio front end circuitry 412 may be coupled to or a part of antenna 411. In some embodiments, WD 410 may not include separate radio front end circuitry 412; rather, processing circuitry 420 may comprise radio front end circuitry and may be connected to antenna 411. Similarly, in some embodiments, some or all of RF transceiver circuitry 422 may be considered a part of interface 414. Radio front end circuitry 412 may receive digital data that is to be sent out to other network nodes or WDs via a wireless connection. Radio front end circuitry 412 may convert the digital data into a radio signal having the appropriate channel and bandwidth parameters using a combination of filters 418 and/or amplifiers 416. The radio signal may then be transmitted via antenna 411. Similarly, when receiving data, antenna 411 may collect radio signals which are then converted into digital data by radio front end circuitry 412. The digital data may be passed to processing circuitry 420. In other embodiments, the interface may comprise different components and/or different combinations of components.

Processing circuitry 420 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 410 components, such as device readable medium 430, WD 410 functionality. Such functionality may include providing any of the various wireless features or benefits discussed herein. For example, processing circuitry 420 may execute instructions stored in device readable medium 430 or in memory within processing circuitry 420 to provide the functionality disclosed herein.

As illustrated, processing circuitry 420 includes one or more of RF transceiver circuitry 422, baseband processing circuitry 424, and application processing circuitry 426. In other embodiments, the processing circuitry may comprise different components and/or different combinations of components. In certain embodiments processing circuitry 420 of WD 410 may comprise a SOC. In some embodiments, RF transceiver circuitry 422, baseband processing circuitry 424, and application processing circuitry 426 may be on separate chips or sets of chips. In alternative embodiments, part or all of baseband processing circuitry 424 and application processing circuitry 426 may be combined into one chip or set of chips, and RF transceiver circuitry 422 may be on a separate chip or set of chips. In still alternative embodiments, part or all of RF transceiver circuitry 422 and baseband processing circuitry 424 may be on the same chip or set of chips, and application processing circuitry 426 may be on a separate chip or set of chips. In yet other alternative embodiments, part or all of RF transceiver circuitry 422, baseband processing circuitry 424, and application processing circuitry 426 may be combined in the same chip or set of chips. In some embodiments, RF transceiver circuitry 422 may be a part of interface 414. RF transceiver circuitry 422 may condition RF signals for processing circuitry 420.

In certain embodiments, some or all of the functionality described herein as being performed by a WD may be provided by processing circuitry 420 executing instructions stored on device readable medium 430, which in certain embodiments may be a computer-readable storage medium. In alternative embodiments, some or all of the functionality may be provided by processing circuitry 420 without executing instructions stored on a separate or discrete device readable storage medium, such as in a hard-wired manner. In any of those particular embodiments, whether executing instructions stored on a device readable storage medium or not, processing circuitry 420 can be configured to perform the described functionality. The benefits provided by such functionality are not limited to processing circuitry 420 alone or to other components of WD 410, but are enjoyed by WD 410 as a whole, and/or by end users and the wireless network generally.

Processing circuitry 420 may be configured to perform any determining, calculating, or similar operations (e.g., certain obtaining operations) described herein as being performed by a WD. These operations, as performed by processing circuitry 420, may include processing information obtained by processing circuitry 420 by, for example, converting the obtained information into other information, comparing the obtained information or converted information to information stored by WD 410, and/or performing one or more operations based on the obtained information or converted information, and as a result of said processing making a determination.

Device readable medium 430 may be operable to store a computer program, software, an application including one or more of logic, rules, code, tables, etc. and/or other instructions capable of being executed by processing circuitry 420. Device readable medium 430 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 420. In some embodiments, processing circuitry 420 and device readable medium 430 may be considered to be integrated.

User interface equipment 432 may provide components that allow for a human user to interact with WD 410. Such interaction may be of many forms, such as visual, audial, tactile, etc. User interface equipment 432 may be operable to produce output to the user and to allow the user to provide input to WD 410. The type of interaction may vary depending on the type of user interface equipment 432 installed in WD 410. For example, if WD 410 is a smart phone, the interaction may be via a touch screen; if WD 410 is a smart meter, the interaction may be through a screen that provides usage (e.g., the number of gallons used) or a speaker that provides an audible alert (e.g., if smoke is detected). User interface equipment 432 may include input interfaces, devices and circuits, and output interfaces, devices and circuits. User interface equipment 432 is configured to allow input of information into WD 410, and is connected to processing circuitry 420 to allow processing circuitry 420 to process the input information. User interface equipment 432 may include, for example, a microphone, a proximity or other sensor, keys/buttons, a touch display, one or more cameras, a USB port, or other input circuitry. User interface equipment 432 is also configured to allow output of information from WD 410, and to allow processing circuitry 420 to output information from WD 410. User interface equipment 432 may include, for example, a speaker, a display, vibrating circuitry, a USB port, a headphone interface, or other output circuitry. Using one or more input and output interfaces, devices, and circuits, of user interface equipment 432, WD 410 may communicate with end users and/or the wireless network, and allow them to benefit from the functionality described herein.

Auxiliary equipment 434 is operable to provide more specific functionality which may not be generally performed by WDs. This may comprise specialized sensors for doing measurements for various purposes, interfaces for additional types of communication such as wired communications etc. The inclusion and type of components of auxiliary equipment 434 may vary depending on the embodiment and/or scenario.

Power source 436 may, in some embodiments, be in the form of a battery or battery pack. Other types of power sources, such as an external power source (e.g., an electricity outlet), photovoltaic devices or power cells, may also be used. WD 410 may further comprise power circuitry 437 for delivering power from power source 436 to the various parts of WD 410 which need power from power source 436 to carry out any functionality described or indicated herein. Power circuitry 437 may in certain embodiments comprise power management circuitry. Power circuitry 437 may additionally or alternatively be operable to receive power from an external power source; in which case WD 410 may be connectable to the external power source (such as an electricity outlet) via input circuitry or an interface such as an electrical power cable. Power circuitry 437 may also in certain embodiments be operable to deliver power from an external power source to power source 436. This may be, for example, for the charging of power source 436. Power circuitry 437 may perform any formatting, converting, or other modification to the power from power source 436 to make the power suitable for the respective components of WD 410 to which power is supplied.

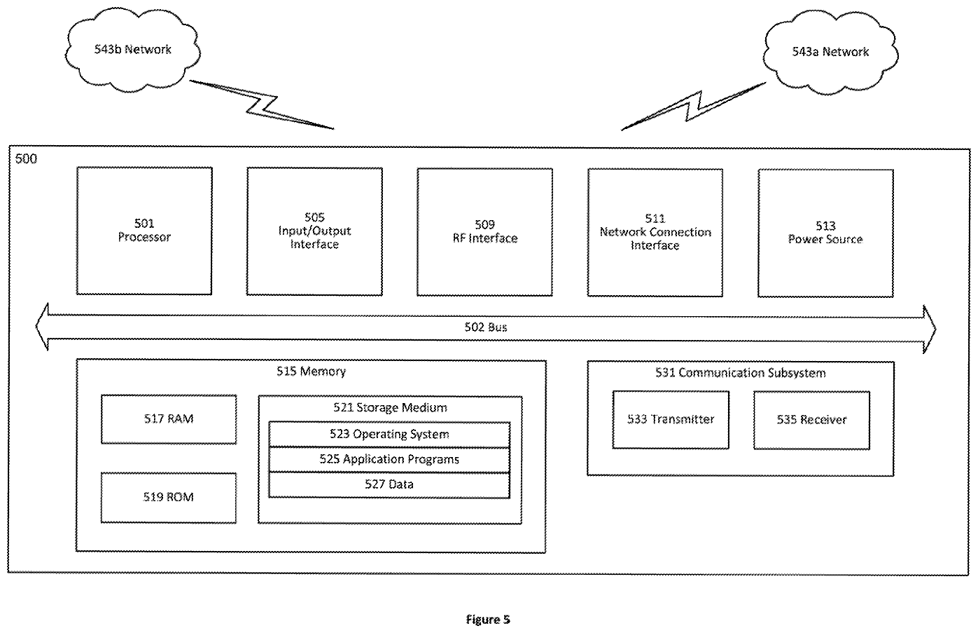

FIG. 5 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 5200 may be any UE identified by the 3rd Generation Partnership Project (3GPP), including a NB-IoT UE, a machine type communication (MTC) UE, and/or an enhanced MTC (eMTC) UE. UE 500, as illustrated in FIG. 5, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 500 includes processing circuitry 501 that is operatively coupled to input/output interface 505, radio frequency (RF) interface 509, network connection interface 511, memory 515 including random access memory (RAM) 517, read-only memory (ROM) 519, and storage medium 521 or the like, communication subsystem 531, power source 533, and/or any other component, or any combination thereof. Storage medium 521 includes operating system 523, application program 525, and data 527. In other embodiments, storage medium 521 may include other similar types of information. Certain UEs may utilize all of the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In the depicted embodiment, input/output interface 505 may be configured to provide a communication interface to an input device, output device, or input and output device. UE 500 may be configured to use an output device via input/output interface 505. An output device may use the same type of interface port as an input device. For example, a USB port may be used to provide input to and output from UE 500. The output device may be a speaker, a sound card, a video card, a display, a monitor, a printer, an actuator, an emitter, a smartcard, another output device, or any combination thereof. UE 500 may be configured to use an input device via input/output interface 505 to allow a user to capture information into UE 500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 509 may be configured to provide a communication interface to RF components such as a transmitter, a receiver, and an antenna. Network connection interface 511 may be configured to provide a communication interface to network 543a. Network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. Network connection interface 511 may be configured to include a receiver and a transmitter interface used to communicate with one or more other devices over a communication network according to one or more communication protocols, such as Ethernet, TCP/IP, SONET, ATM, or the like. Network connection interface 511 may implement receiver and transmitter functionality appropriate to the communication network links (e.g., optical, electrical, and the like). The transmitter and receiver functions may share circuit components, software or firmware, or alternatively may be implemented separately.

RAM 517 may be configured to interface via bus 502 to processing circuitry 501 to provide storage or caching of data or computer instructions during the execution of software programs such as the operating system, application programs, and device drivers. ROM 519 may be configured to provide computer instructions or data to processing circuitry 501. For example, ROM 519 may be configured to store invariant low-level system code or data for basic system functions such as basic input and output (I/O), startup, or reception of keystrokes from a keyboard that are stored in a non-volatile memory. Storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 521 may be configured to include operating system 523, application program 525 such as a web browser application, a widget or gadget engine or another application, and data file 527. Storage medium 521 may store, for use by UE 500, any of a variety of various operating systems or combinations of operating systems.

Storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 521 may allow UE 500 to access computer-executable instructions, application programs or the like, stored on transitory or non-transitory memory media, to off-load data, or to upload data. An article of manufacture, such as one utilizing a communication system may be tangibly embodied in storage medium 521, which may comprise a device readable medium.

In FIG. 5, processing circuitry 501 may be configured to communicate with network 543b using communication subsystem 531. Network 543a and network 543b may be the same network or networks or different network or networks. Communication subsystem 531 may be configured to include one or more transceivers used to communicate with network 543b. For example, communication subsystem 531 may be configured to include one or more transceivers used to communicate with one or more remote transceivers of another device capable of wireless communication such as another WD, UE, or base station of a radio access network (RAN) according to one or more communication protocols, such as IEEE 802.5, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software or firmware, or alternatively may be implemented separately.

In the illustrated embodiment, the communication functions of communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 531 may include cellular communication, Wi-Fi communication, Bluetooth communication, and GPS communication. Network 543b may encompass wired and/or wireless networks such as a local-area network (LAN), a wide-area network (WAN), a computer network, a wireless network, a telecommunications network, another like network or any combination thereof. For example, network 543b may be a cellular network, a Wi-Fi network, and/or a near-field network. Power source 513 may be configured to provide alternating current (AC) or direct current (DC) power to components of UE 500.

The features, benefits and/or functions described herein may be implemented in one of the components of UE 500 or partitioned across multiple components of UE 500. Further, the features, benefits, and/or functions described herein may be implemented in any combination of hardware, software or firmware. In one example, communication subsystem 531 may be configured to include any of the components described herein. Further, processing circuitry 501 may be configured to communicate with any of such components over bus 502. In another example, any of such components may be represented by program instructions stored in memory that when executed by processing circuitry 501 perform the corresponding functions described herein. In another example, the functionality of any of such components may be partitioned between processing circuitry 501 and communication subsystem 531. In another example, the non-computationally intensive functions of any of such components may be implemented in software or firmware and the computationally intensive functions may be implemented in hardware.

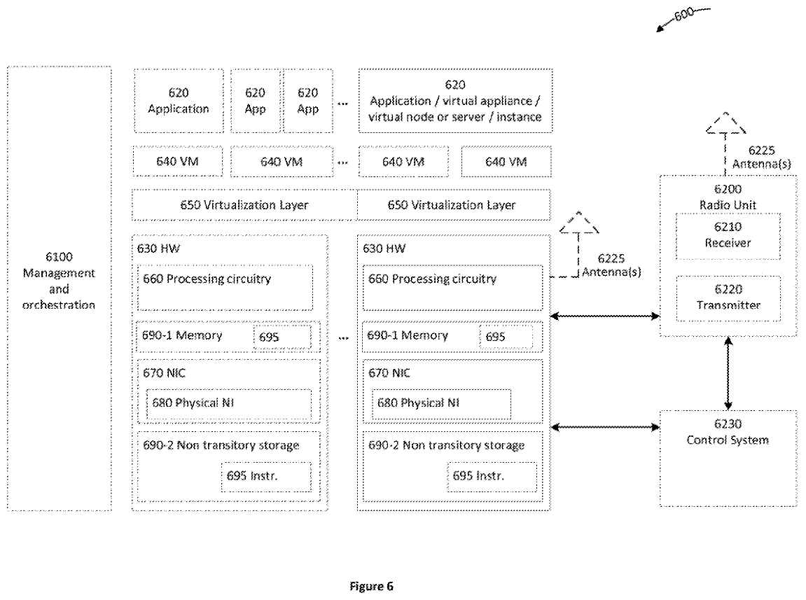

FIG. 6 is a schematic block diagram illustrating a virtualization environment 600 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 600 hosted by one or more of hardware nodes 630. Further, in embodiments in which the virtual node is not a radio access node or does not require radio connectivity (e.g., a core network node), then the network node may be entirely virtualized.

The functions may be implemented by one or more applications 620 (which may alternatively be called software instances, virtual appliances, network functions, virtual nodes, virtual network functions, etc.) operative to implement some of the features, functions, and/or benefits of some of the embodiments disclosed herein. Applications 620 are run in virtualization environment 600 which provides hardware 630 comprising processing circuitry 660 and memory 690. Memory 690 contains instructions 695 executable by processing circuitry 660 whereby application 620 is operative to provide one or more of the features, benefits, and/or functions disclosed herein.

Virtualization environment 600, comprises general-purpose or special-purpose network hardware devices 630 comprising a set of one or more processors or processing circuitry 660, which may be commercial off-the-shelf (COTS) processors, dedicated Application Specific Integrated Circuits (ASICs), or any other type of processing circuitry including digital or analog hardware components or special purpose processors. Each hardware device may comprise memory 690-1 which may be non-persistent memory for temporarily storing instructions 695 or software executed by processing circuitry 660. Each hardware device may comprise one or more network interface controllers (NICs) 670, also known as network interface cards, which include physical network interface 680. Each hardware device may also include non-transitory, persistent, machine-readable storage media 690-2 having stored therein software 695 and/or instructions executable by processing circuitry 660. Software 695 may include any type of software including software for instantiating one or more virtualization layers 650 (also referred to as hypervisors), software to execute virtual machines 640 as well as software allowing it to execute functions, features and/or benefits described in relation with some embodiments described herein.

Virtual machines 640, comprise virtual processing, virtual memory, virtual networking or interface and virtual storage, and may be run by a corresponding virtualization layer 650 or hypervisor. Different embodiments of the instance of virtual appliance 620 may be implemented on one or more of virtual machines 640, and the implementations may be made in different ways.

During operation, processing circuitry 660 executes software 695 to instantiate the hypervisor or virtualization layer 650, which may sometimes be referred to as a virtual machine monitor (VMM). Virtualization layer 650 may present a virtual operating platform that appears like networking hardware to virtual machine 640.

As shown in FIG. 6, hardware 630 may be a standalone network node with generic or specific components. Hardware 630 may comprise antenna 6225 and may implement some functions via virtualization. Alternatively, hardware 630 may be part of a larger cluster of hardware (e.g. such as in a data center or customer premise equipment (CPE)) where many hardware nodes work together and are managed via management and orchestration (MANO) 6100, which, among others, oversees lifecycle management of applications 620.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 640 may be a software implementation of a physical machine that runs programs as if they were executing on a physical, non-virtualized machine. Each of virtual machines 640, and that part of hardware 630 that executes that virtual machine, be it hardware dedicated to that virtual machine and/or hardware shared by that virtual machine with others of the virtual machines 640, forms a separate virtual network elements (VNE).

Still in the context of NFV, Virtual Network Function (VNF) is responsible for handling specific network functions that run in one or more virtual machines 640 on top of hardware networking infrastructure 630 and corresponds to application 620 in FIG. 6.

In some embodiments, one or more radio units 6200 that each include one or more transmitters 6220 and one or more receivers 6210 may be coupled to one or more antennas 6225. Radio units 6200 may communicate directly with hardware nodes 630 via one or more appropriate network interfaces and may be used in combination with the virtual components to provide a virtual node with radio capabilities, such as a radio access node or a base station.

In some embodiments, some signalling can be effected with the use of control system 6230 which may alternatively be used for communication between the hardware nodes 630 and radio units 6200.

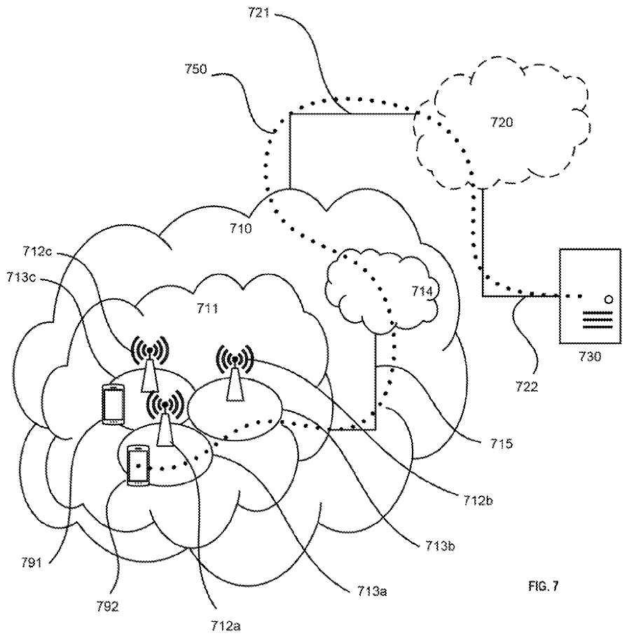

With reference to FIG. 7, a communication system in accordance with an embodiment is shown. The illustrated communication system includes telecommunication network 710, such as a 3GPP-type cellular network, which comprises access network 711, such as a radio access network, and core network 714. Access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to core network 714 over a wired or wireless connection 715. A first UE 791 located in coverage area 713c is configured to wirelessly connect to, or be paged by, the corresponding base station 712c. A second UE 792 in coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

Telecommunication network 710 is itself connected to host computer 730, which may be embodied in the hardware and/or software of a standalone server, a cloud-implemented server, a distributed server or as processing resources in a server farm. Host computer 730 may be under the ownership or control of a service provider, or may be operated by the service provider or on behalf of the service provider. Connections 721 and 722 between telecommunication network 710 and host computer 730 may extend directly from core network 714 to host computer 730 or may go via an optional intermediate network 720. Intermediate network 720 may be one of, or a combination of more than one of, a public, private or hosted network; intermediate network 720, if any, may be a backbone network or the Internet; in particular, intermediate network 720 may comprise two or more sub-networks (not shown).

The communication system of FIG. 7 as a whole enables connectivity between the connected UEs 791, 792 and host computer 730. The connectivity may be described as an over-the-top (OTT) connection 750. Host computer 730 and the connected UEs 791, 792 are configured to communicate data and/or signalling via OTT connection 750, using access network 711, core network 714, any intermediate network 720 and possible further infrastructure (not shown) as intermediaries. OTT connection 750 may be transparent in the sense that the participating communication devices through which OTT connection 750 passes are unaware of routing of uplink and downlink communications. For example, base station 712 may not or need not be informed about the past routing of an incoming downlink communication with data originating from host computer 730 to be forwarded (e.g., handed over) to a connected UE 791. Similarly, base station 712 need not be aware of the future routing of an outgoing uplink communication originating from the UE 791 towards the host computer 730.

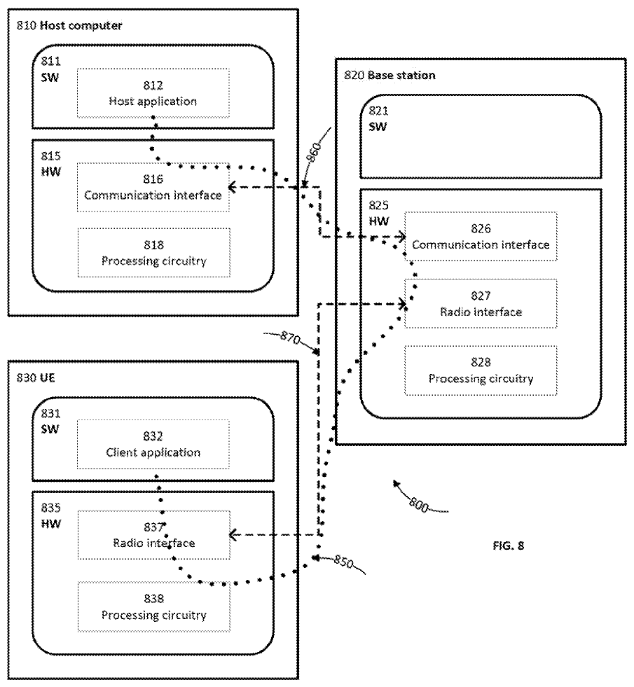

Example implementations, in accordance with an embodiment, of the UE, base station and host computer discussed in the preceding paragraphs will now be described with reference to FIG. 8. In communication system 800, host computer 810 comprises hardware 815 including communication interface 816 configured to set up and maintain a wired or wireless connection with an interface of a different communication device of communication system 800. Host computer 810 further comprises processing circuitry 818, which may have storage and/or processing capabilities. In particular, processing circuitry 818 may comprise one or more programmable processors, application-specific integrated circuits, field programmable gate arrays or combinations of these (not shown) adapted to execute instructions. Host computer 810 further comprises software 811, which is stored in or accessible by host computer 810 and executable by processing circuitry 818. Software 811 includes host application 812. Host application 812 may be operable to provide a service to a remote user, such as UE 830 connecting via OTT connection 850 terminating at UE 830 and host computer 810. In providing the service to the remote user, host application 812 may provide user data which is transmitted using OTT connection 850.

Communication system 800 further includes base station 820 provided in a telecommunication system and comprising hardware 825 enabling it to communicate with host computer 810 and with UE 830. Hardware 825 may include communication interface 826 for setting up and maintaining a wired or wireless connection with an interface of a different communication device of communication system 800, as well as radio interface 827 for setting up and maintaining at least wireless connection 870 with UE 830 located in a coverage area (not shown in FIG. 8) served by base station 820. Communication interface 826 may be configured to facilitate connection 860 to host computer 810. Connection 860 may be direct or it may pass through a core network (not shown in FIG. 8) of the telecommunication system and/or through one or more intermediate networks outside the telecommunication system. In the embodiment shown, hardware 825 of base station 820 further includes processing circuitry 828, which may comprise one or more programmable processors, application-specific integrated circuits, field programmable gate arrays or combinations of these (not shown) adapted to execute instructions. Base station 820 further has software 821 stored internally or accessible via an external connection.

Communication system 800 further includes UE 830 already referred to. Its hardware 835 may include radio interface 837 configured to set up and maintain wireless connection 870 with a base station serving a coverage area in which UE 830 is currently located. Hardware 835 of UE 830 further includes processing circuitry 838, which may comprise one or more programmable processors, application-specific integrated circuits, field programmable gate arrays or combinations of these (not shown) adapted to execute instructions. UE 830 further comprises software 831, which is stored in or accessible by UE 830 and executable by processing circuitry 838. Software 831 includes client application 832. Client application 832 may be operable to provide a service to a human or non-human user via UE 830, with the support of host computer 810. In host computer 810, an executing host application 812 may communicate with the executing client application 832 via OTT connection 850 terminating at UE 830 and host computer 810. In providing the service to the user, client application 832 may receive request data from host application 812 and provide user data in response to the request data. OTT connection 850 may transfer both the request data and the user data. Client application 832 may interact with the user to generate the user data that it provides.

It is noted that host computer 810, base station 820 and UE 830 illustrated in FIG. 8 may be similar or identical to host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, OTT connection 850 has been drawn abstractly to illustrate the communication between host computer 810 and UE 830 via base station 820, without explicit reference to any intermediary devices and the precise routing of messages via these devices. Network infrastructure may determine the routing, which it may be configured to hide from UE 830 or from the service provider operating host computer 810, or both. While OTT connection 850 is active, the network infrastructure may further take decisions by which it dynamically changes the routing (e.g., on the basis of load balancing consideration or reconfiguration of the network).

Wireless connection 870 between UE 830 and base station 820 is in accordance with the teachings of the embodiments described throughout this disclosure. One or more of the various embodiments improve the performance of OTT services provided to UE 830 using OTT connection 850, in which wireless connection 870 forms the last segment. More precisely, the teachings of these embodiments may improve the latency and reliability and thereby provide benefits such as reduced user waiting time, relaxed restriction on file size, better responsiveness, etc.

A measurement procedure may be provided for the purpose of monitoring data rate, latency and other factors on which the one or more embodiments improve. There may further be an optional network functionality for reconfiguring OTT connection 850 between host computer 810 and UE 830, in response to variations in the measurement results. The measurement procedure and/or the network functionality for reconfiguring OTT connection 850 may be implemented in software 811 and hardware 815 of host computer 810 or in software 831 and hardware 835 of UE 830, or both. In embodiments, sensors (not shown) may be deployed in or in association with communication devices through which OTT connection 850 passes; the sensors may participate in the measurement procedure by supplying values of the monitored quantities exemplified above, or supplying values of other physical quantities from which software 811, 831 may compute or estimate the monitored quantities. The reconfiguring of OTT connection 850 may include message format, retransmission settings, preferred routing etc.; the reconfiguring need not affect base station 820, and it may be unknown or imperceptible to base station 820. Such procedures and functionalities may be known and practiced in the art. In certain embodiments, measurements may involve proprietary UE signalling facilitating host computer 810's measurements of throughput, propagation times, latency and the like. The measurements may be implemented in that software 811 and 831 causes messages to be transmitted, in particular empty or ‘dummy’ messages, using OTT connection 850 while it monitors propagation times, errors etc.

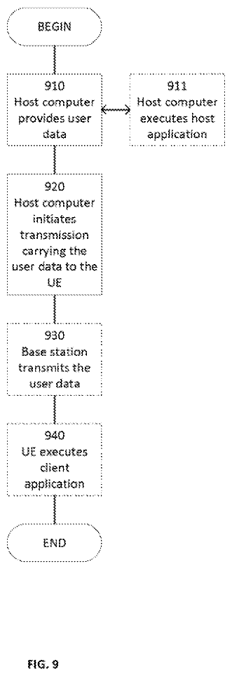

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

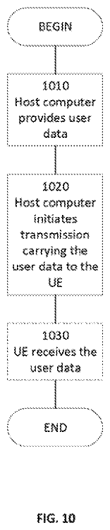

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

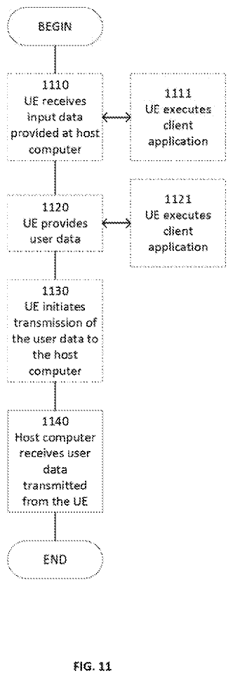

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

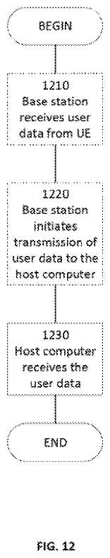

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

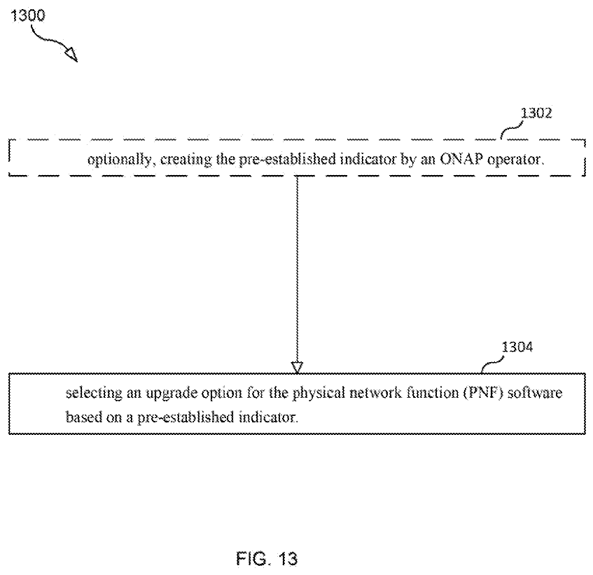

FIG. 13 is a flow diagram for PNF software upgrade according to some embodiments. In some embodiments, the method 1300 of FIG. 13 is performed by selecting an upgrade option for the physical network function (PNF) software based on a pre-established indicator at step 1304. At optional step 1302, the pre-established indicator may be created by an ONAP operator.

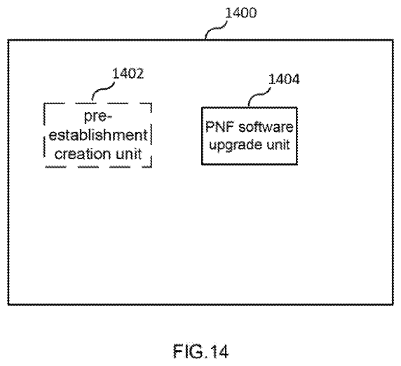

FIG. 14 illustrates a schematic block diagram of an apparatuses 1400, in a wireless network (for example, the wireless network shown in FIG. 4). The apparatus may be implemented in a wireless device or network node (e.g., wireless device 410 or network node 460 shown in FIG. 4). Apparatus 1400 is operable to carry out the example methods described with reference to FIG. 13 respectively and possibly any other processes or methods disclosed herein. It is also to be understood that the methods of FIG. 13 is not necessarily carried out solely by apparatuses 1400. At least some operations of the method can be performed by one or more other entities.

Virtual apparatuses 1400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause a horizontal beamforming unit 1402, an optional elevation beamforming unit 1404 and/or any other suitable units of apparatuses 1400 to perform corresponding functions according one or more embodiments of the present disclosure.

As illustrated in FIG. 14, apparatus 1400 includes a PNF software upgrade unit 1404 that utilizes a pre-established indicator to upgrade PNF instances. An optional, pre-establishment creation unit 1402 may be included within apparatus 1400. This pre-establishment unit 1402 may be utilized by an ONAP operator. The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Abbreviations

At least some of the following abbreviations may be used in this disclosure. If there is an inconsistency between abbreviations, preference should be given to how it is used above. If listed multiple times below, the first listing should be preferred over any subsequent listing(s).

### PRH PNF Registration Handler

### ONAP Open Network Automation Platform

PNF Physical network function

### eIM Edge Infrastructure Manager

### EC External Controller

### SO Service Orchestrator

### DCAE Data Collection, Analytics and Events

### AAI Active and Available Inventory

### VIA Virtual Infrastructure Deployment

### OOF ONAP Optimization Framework

### 1×RTT CDMA2000 1× Radio Transmission Technology

### 3GPP 3rd Generation Partnership Project

### 5G 5th Generation

### ABS Almost Blank Subframe

### ARQ Automatic Repeat Request

### AWGN Additive White Gaussian Noise

### BCCH Broadcast Control Channel

### BCH Broadcast Channel

### CA Carrier Aggregation

### CC Carrier Component

### CCCH SDU Common Control Channel SDU

### CDMA Code Division Multiplexing Access

### CGI Cell Global Identifier

### CIR Channel Impulse Response

### CP Cyclic Prefix

### CPICH Common Pilot Channel

CPICH Ec/No CPICH Received energy per chip divided by the power density in the band
CQI Channel Quality information

### C-RNTI Cell RNTI

### CSI Channel State Information

### DCCH Dedicated Control Channel

### DL Downlink

### DM Demodulation

### DMRS Demodulation Reference Signal

### DRX Discontinuous Reception

### DTX Discontinuous Transmission

### DTCH Dedicated Traffic Channel

### DUT Device Under Test

E-CID Enhanced Cell-ID (positioning method)

### E-SMLC Evolved-Serving Mobile Location Centre

### ECGI Evolved CGI

### eNB E-UTRAN NodeB

ePDCCH enhanced Physical Downlink Control Channel
E-SMLC evolved Serving Mobile Location Center

### E-UTRA Evolved UTRA

### E-UTRAN Evolved UTRAN

### FDD Frequency Division Duplex

### FFS For Further Study

### GERAN GSM EDGE Radio Access Network

gNB Base station in NR

### GNSS Global Navigation Satellite System

GSM Global System for Mobile communication

### HARQ Hybrid Automatic Repeat Request

### HO Handover

### HSPA High Speed Packet Access

### HRPD High Rate Packet Data

### LOS Line of Sight

### LPP LTE Positioning Protocol

### LTE Long-Term Evolution

### MAC Medium Access Control

### MBMS Multimedia Broadcast Multicast Services

MBSFN Multimedia Broadcast multicast service Single Frequency Network

### MBSFN ABS MBSFN Almost Blank Subframe

### MDT Minimization of Drive Tests

### MIB Master Information Block

### MME Mobility Management Entity

### MSC Mobile Switching Center

### NPDCCH Narrowband Physical Downlink Control Channel

### NR New Radio

### OCNG OFDMA Channel Noise Generator

### OFDM Orthogonal Frequency Division Multiplexing

### OFDMA Orthogonal Frequency Division Multiple Access

### OSS Operations Support System

### OTDOA Observed Time Difference of Arrival

### O&M Operation and Maintenance

### PBCH Physical Broadcast Channel

### P-CCPCH Primary Common Control Physical Channel

### PCell Primary Cell

### PCFICH Physical Control Format Indicator Channel

### PDCCH Physical Downlink Control Channel

### PDP Profile Delay Profile

### PDSCH Physical Downlink Shared Channel

### PGW Packet Gateway

### PHICH Physical Hybrid-ARQ Indicator Channel

### PLMN Public Land Mobile Network

### PMI Precoder Matrix Indicator

### PRACH Physical Random Access Channel

### PRS Positioning Reference Signal

### PSS Primary Synchronization Signal

### PUCCH Physical Uplink Control Channel

### PUSCH Physical Uplink Shared Channel

### RACH Random Access Channel

### QAM Quadrature Amplitude Modulation

### RAN Radio Access Network

### RAT Radio Access Technology

### RLM Radio Link Management

### RNC Radio Network Controller

### RNTI Radio Network Temporary Identifier

### RRC Radio Resource Control

### RRM Radio Resource Management

### RS Reference Signal

### RSCP Received Signal Code Power

### RSRP Reference Symbol Received Power OR

### Reference Signal Received Power

### RSRQ Reference Signal Received Quality OR

### Reference Symbol Received Quality

### RSSI Received Signal Strength Indicator

### RSTD Reference Signal Time Difference

### SCH Synchronization Channel

### SCell Secondary Cell

### SDU Service Data Unit

### SFN System Frame Number

### SGW Serving Gateway

### SI System Information

### SIB System Information Block

### SNR Signal to Noise Ratio

### SON Self Optimized Network

### SS Synchronization Signal

### SSS Secondary Synchronization Signal

### TDD Time Division Duplex

### TDOA Time Difference of Arrival

### TOA Time of Arrival

### TSS Tertiary Synchronization Signal

### TTI Transmission Time Interval

### UE User Equipment

### UL Uplink

### UMTS Universal Mobile Telecommunication System

### USIM Universal Subscriber Identity Module

### UTDOA Uplink Time Difference of Arrival

### UTRA Universal Terrestrial Radio Access

### UTRAN Universal Terrestrial Radio Access Network

### WCDMA Wide CDMA

### WLAN Wide Local Area Network

### PRH PNF Registration Handler

### DMAAP Data Movement as a Platform

### DG Data Graph

### ONAP Open Network Automation Platform

PNF Physical network function

### eIM Edge Infrastructure Manager

### EC External Controller

### EM External Management

### SO Service Orchestrator

### SDNC Software Defined Network Controller

### DCAE Data Collection, Analytics and Events

### A&Al Active and Available Inventory

### VID Virtual Infrastructure Deployment

### OOF ONAP Optimization Framework

1. A method for upgrading network function (NF) software, the method comprising:
selecting a software upgrade option for the network function (NF) software, the upgrade being based on a pre-established indicator.

2. The method of claim 1 wherein the pre-established indicator created by an ONAP operator.

3. The method of claim 1, wherein the upgrade option is a build-replace update using a new NF package.

4. The method of claim 1, wherein the upgrade option is an in-place update using a new NF package.

5. The method of claim 1, wherein the upgrade option is an in-place update using get-schema.

6. The method of claim 1, wherein the upgrade option is an in-place update using file-ready.

7. The method of claim 1, further comprising selecting a supported update option if the selected upgrade option is not supported.

8. The method of claim 1, further comprising rejecting the upgrade option if the selected upgrade option is not supported.

9. The method of claim 1, further comprising conducting a pre-check to determine if a set of pre-conditions are satisfied.

10. The method of claim 9, wherein the pre-requirements may be selected from one or more of the group consisting of: a determination that the DMaaP is up and running, an Active and Available Inventory (A&AI) is up and running with a valid NF entry, the SDNC is up and running, an external monitor (EM) and NF are up and running with assigned IP addresses and ports, and the NF instance is ready to send a NF registration VES event.

11. The method of claim 9, wherein the pre-requirements may be selected from one or more of the group consisting of: ONAP is ready to use, at least one SO upgrade workflow is ready to use, a SDC service template with one NF resource is designed and is distributed to run time, and service instantiation is completed.

12. The method of claim 1, further comprising:
prior to the selecting an upgrade option for the network function (NF) software, an operator selecting a work-flow and a NF instance to be upgraded, providing a target software version of the NF instance, and initiating the upgrade procedure to upgrade the NF instance.

13. The method of claim 1, further comprising:
a service orchestrator (SO) sending at least one request to a controller to upgrade the NF instance, the at least one request including the pre-established indicator;
the controller executing the at least one request to facilitate the upgrading of the NF instance where the execution is based on the pre-established indicator; and
the SO updating the NF instance's information on an Active and Available Inventory (A&AI) when the upgrade is completed.

14. The method of claim 1, wherein the network function (NF) is a physical network function (PNF).

15. The method of claim 1, wherein the network function (NF) is a virtual network function (VNF).

16. The method of claim 1, wherein the network element is any network function (xNF).

17. A computer program comprising instructions which, when executed by at least one processor and to perform by the at least one processor the selection a software upgrade option for the network function (NF) software, the upgrade being based on a pre-established indicator.

18. A system that upgrades a plurality of network elements with a single procedure, the system comprising:
one or more processors; and
memory storing instructions that, when executed by the one or more processors, cause the system to:
select a software upgrade option for the network function (NF) software, the upgrade being based on a pre-established indicator.

19. A non-transitory computer readable medium comprising instructions that, when executed, cause one or more processors to:
select a software upgrade option for the network function (NF) software, the upgrade being based on a pre-established indicator.
